(19) United States
(12) Patent Application Publication
(10) Pub. No.: US 2005/0253954 A1
(43) Pub. Date: Nov. 17, 2005

(54) Focus adjusting device and focus adjusting method

(75) Inventors: Toshiyuki Nakashima, Osaka (JP); Toshiya Kogishi, Kyoto (JP); Kenji Arakawa, Osaka (JP); Toshinobu Hatano, Kyoto (JP); Jun Kajiwara, Kyoto (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/127,209

(22) Filed: May 12, 2005

(30) Foreign Application Priority Data
May 13, 2004 (JP) P2004-143477
Apr. 28, 2005 (JP) P2005-132659

(51) Int. Cl. H04N 5/232

(52) U.S. Cl. 348/345

(57) ABSTRACT

A focus adjusting method for focusing a focus of a digital camera comprises an image signal converting step in which an imaging light entering an optical lens mechanism is converted into an image signal, an extracting step in which a high-frequency component of the image signal is selectively extracted, a signal generating step in which a luminance signal and a color difference signal are generated from the high-frequency component of the image signal selectively extracted, and a focus adjusting step in which a focusing position of the optical lens mechanism is adjusted using a high-frequency component of the luminance signal. According to the foregoing constitution, a focus adjustment can be realized with a high accuracy and at a high speed.

### FIELD OF THE INVENTION

The present invention relates to a technology for adjusting a focus with a high accuracy and at a high speed in a digital camera, a typical example of which is a digital still camera.

### BACKGROUND OF THE INVENTION

In a conventional digital camera such as a digital still camera and a camera-incorporated mobile phone, a color filter is disposed in front of an image pickup device comprised of a plurality of pixels so as to obtain data in which one pixel constitute one color. A DSP (Digital Signal Processor) acquires a luminance component and a hue component (YC component) of each pixel from a data array in an output of the image pickup device to thereby execute a monitor output and record a still image.

A digital camera, which adjusts a focus using a high-frequency luminance component, is conventionally available. No. 05-330976 of the Publication of the Unexamined Japanese Patent Applications discloses a basic principle in adjusting the focus using the high-frequency luminance component.

However, because the luminance component is generated from the color-arrayed pixel in the digital camera, as mentioned above, and the high-frequency luminance component is disadvantageously lost. Therefore, it takes a long time to reach a focusing point in the case of adjusting the focus using the high-frequency luminance component.

### SUMMARY OF THE INVENTION

Therefore, a main object of the present invention is to provide a method of realizing an auto focus at a high speed and with a high accuracy.

A focus adjusting method according to the present invention, in order to solve the foregoing problem, comprises an image signal converting step in which an imaging light entering an optical lens mechanism is converted into an image signal, an extracting step in which a high-frequency component of the image signal is selectively extracted, a signal generating step in which a luminance signal and a color difference signal are generated from the high-frequency component of the image signal selectively extracted, and a focus adjusting step in which a focusing position of the optical lens mechanism is adjusted using a high-frequency component of the luminance signal.

A focus adjusting device according to the present invention comprises an optical lens mechanism, an image pickup device for converting an imaging light entering the optical lens mechanism into an image signal, an extracting unit for extracting a high-frequency component of the image signal, a signal processing unit for generating a luminance signal and a color difference signal from the high-frequency component of the image signal extracted by the extracting unit and a focus adjusting unit for adjusting a focusing position of the optical lens mechanism using a high-frequency component of the luminance signal.

According to the present invention, the focus adjustment can be fast and accurately implemented.

### BRIEF DESCRIPTION OF THE DRAWINGS

These and other objects as well as advantages of the invention will become clear by the following description of preferred embodiments and explicit in the appended claims of the invention. Many other benefits of the invention, which are not cited in this specification, will come to the attention of those skilled in the art upon implementing the present invention.

FIG. 1 shows a frequency characteristic when a YC signal is generated.

FIG. 2 is a block diagram illustrating a constitution of a digital camera according to the present invention.

FIG. 3 shows a frequency characteristic of a band pass filter according to the present invention.

FIG. 4 is a flow chart of a focus adjusting method according to an embodiment 1 of the present invention.

FIG. 5 is a flow chart of a focus adjusting method according to an embodiment 2 of the present invention.

### DESCRIPTION OF THE PREFERRED EMBODIMENTS

Hereinafter, preferred embodiments of the present invention are described referring to the drawings. In the embodiments of the present invention, a focus adjustment is implemented by extracting a high-frequency component of an image.

### Embodiment 1

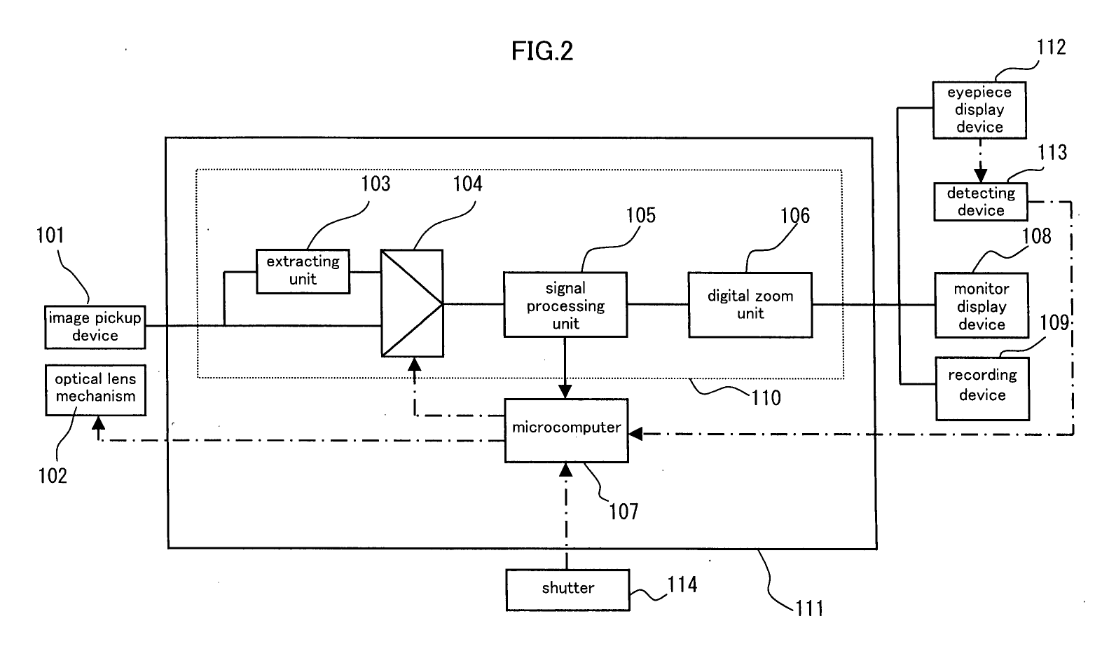

An embodiment 1 of the present invention is described referring to the drawings. FIG. 2 shows a digital camera according to the embodiment 1. A reference numeral 101 denotes an image pickup device. An optical lens mechanism (hereinafter, referred to as lens mechanism) 102 is disposed forward in an imaging direction of the image pickup device 101. The lens mechanism 102 beam-condenses an image of a photographic object on the image pickup device 101. The image pickup device 101 converts an optical signal condensed by the lens mechanism 102 into an image signal (electric signal) and outputs it. A timing by which the image is picked up by the image pickup device 101 is controlled by a pressing operation implemented by a user of the camera with respect to a shutter 114. The image signal outputted from the image pickup device 101 is converted into a digital image signal by an AD converter not shown. The digital image signal is processed in a digital signal processor (hereinafter, referred to as DSP) 110. The DSP 110 comprises a extracting unit 103, a selecting unit 104, a signal processing unit 105 and a digital zoom unit 106. The extracting unit 103 is comprised of, for example, a digital band pass filter having a characteristic of amplifying a gain of a high-frequency component from the image signal. The extracting unit 103 exerts the foregoing characteristic to thereby selectively extract the high-frequency component of the image signal.

The extracting unit 103, selecting unit 104, signal processing unit 105 and digital zoom unit 106 may be provided in the DSP 110 as circuits, or may be processed in a software manner by means of a computing unit provided in the DSP 110. In the present embodiment, a microcomputer 107 constitutes a focus adjusting unit, and the DSP 110 and the microcomputer 107 constitute a focus adjusting device 111.

First, an outline of a focus adjustment implemented by the focus adjusting device 111 according to the present embodiment is described. The signal processing unit 105 generates a luminance signal and a color difference signal from the digital image signal and outputs it to the digital zoom unit 106, while outputting the luminance signal to the microcomputer 107.

The microcomputer 107 executes a DCT operation to the supplied luminance signal to thereby obtain a conversion coefficient, and further, eliminates a DC component from the computed conversion coefficient to thereby obtain an AC conversion coefficient. The microcomputer 107 executes the following focusing control based on the obtained AC conversion coefficient.

In the case of executing the focusing control using the AC conversion coefficient, the AC conversion coefficient shows a peak level at a focusing position. Further, a variation degree of the AC conversion coefficient in response to a changing lens position changes based on a frequency, and the variation of the high-frequency-side coefficient is larger than the variation of the low-frequency-side coefficient in a vicinity of the focusing position. The microcomputer 107 utilizes the described increase/decrease characteristic of the AC conversion coefficient to thereby execute the focusing process using the high-frequency component of the AC conversion coefficient, and achieves an improved focusing accuracy and focusing speed.

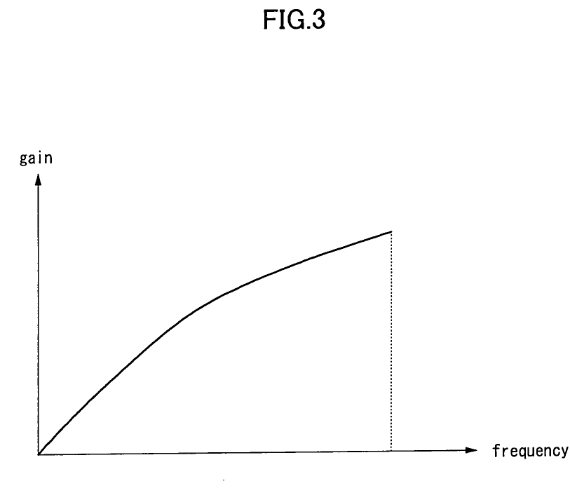

FIG. 3 shows a characteristic of the extracting unit 103. As shown in FIG. 3, the extracting unit 103 has the characteristic of amplifying the gain of the high-frequency component from the image signal representing the image of the photographic object. Any image signal passing through the extracting unit 103 fails to accurately represent the image of the photographic object, resulting in a digital image signal in which the high-frequency component is selectively emphasized, that is a digital image signal from which the high-frequency component is selectively extracted.

The selecting unit 104 selects from the digital image signal passing through the extracting unit 103 and the digital image signal not passing through the extracting unit 103 and outputs the selected result. The signal processing unit 105 generates the luminance signal and the color difference signal from the digital image signal outputted from the selecting unit 104. The generated luminance signal and the color difference signal are subjected to a digital zoom process (image enlargement/image reduction) to be reduced to an optional size in the digital zoom unit 106, and thereafter outputted to a monitor display device 108 in the case of a monitor output mode. In contrast, the generated luminance signal and the color difference signal, at the time of the image pickup, are compressed in a compressing unit not shown and outputted to a recording device 109 to be recorded as images.

The luminance signal generated by the signal processing unit 105 is also outputted to the microcomputer 107. The microcomputer 107 adjusts a focus of the lens mechanism 102 using the high-frequency component of the luminance signal supplied from the signal processing unit 105. More specifically, the microcomputer 107 controls a lens position adjusting device (not shown) of the lens mechanism 102, while searching a lens position at which a signal level of the high-frequency component (high-frequency component of the AC conversion coefficient) is at a peak level, and defines the lens position as a focusing position of the lens mechanism 102.

The focus adjusting device 111 according to the present embodiment has a two-chip constitution in which the DSP 110 processes the image and the microcomputer 107 adjusts the focus, however, the present invention is not limited to the foregoing constitution. For example, all of the described processes may be executed in one chip.

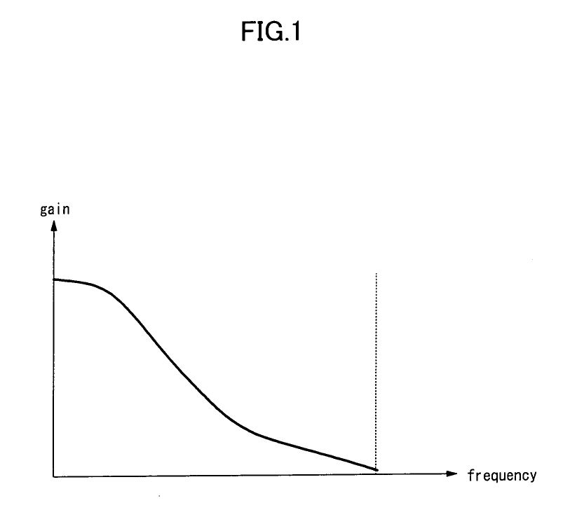

A focus adjusting method employed in the digital camera (focus adjusting device 111) constituted as shown in FIG. 1 is described in detail as follows.

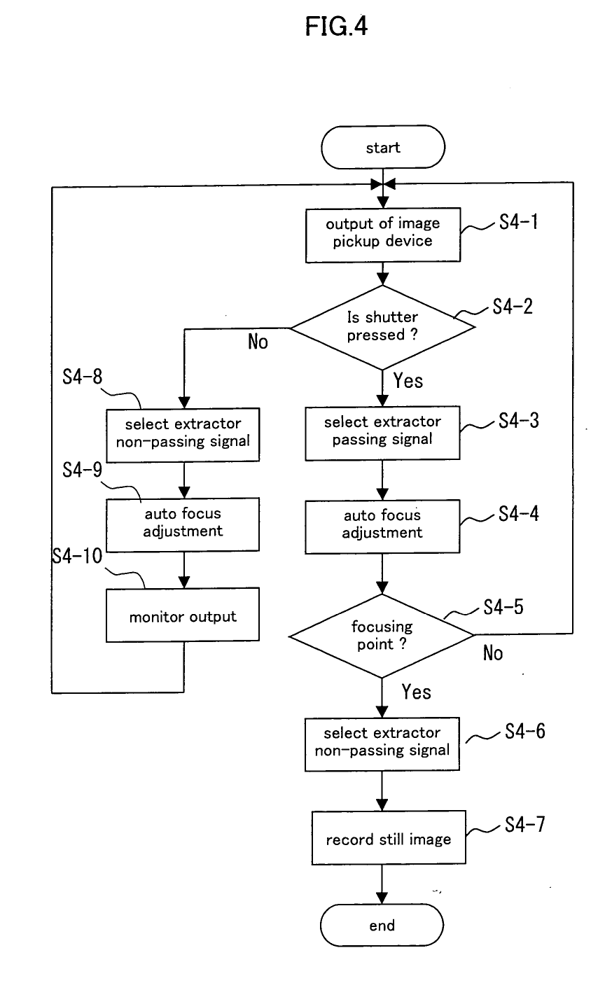

FIG. 4 is a flow chart illustrating the focus adjusting method implemented by the focus adjusting device 111 according to the present embodiment. The image pickup device 101 outputs an electric image signal generated in the image pickup process while the digital camera is in an activated state (Step S4-1). In the foregoing state, the microcomputer 107 monitors whether or not the shutter 114 is pressed (Step S4-2).

When the microcomputer 107 detects that the shutter 114 has been pressed in the Step 4-2, the microcomputer 107 outputs an instruction of selecting the digital image signal which passed through the extracting unit 103 (hereinafter, referred to as extractor passing signal) to the selecting unit 104. The selecting unit 104 receives the selecting instruction from the microcomputer 107, and selects the extractor passing signal based on the instruction and outputs it (Step S4-3).

The luminance signal generated by the signal processing unit 105 based on the ordinary digital image signal not passing through the extracting unit 103 (hereinafter, referred to as extractor non-passing signal) has a frequency characteristic in which the gain of the high-frequency component is reduced as shown in FIG. 1 based on a characteristic of the signal processing unit 105. In contrast, the extractor passing signal has a frequency characteristic in which the gain of the high-frequency component is selectively amplified. Therefore, the luminance signal generated in the signal processing unit 105 based on the extractor passing signal has an abundant volume of information on the high-frequency component for the focusing control.

The microcomputer 107 extracts the high-frequency component from the luminance signal generated by the signal processing unit 105 based on the extractor passing signal and adjusts the focus using the high-frequency component (Step S4-4). The focus adjustment is implemented by calculating a moving distance of the lens by means of a calculation process using the high-frequency component and moving the lens of the lens mechanism 102 by the calculated moving distance. The microcomputer 107 activates the lens mechanism 102 and thereafter judges whether or not the lens position has reached the focusing position (Step S4-5). The state in which the lens position is at the focusing position is referred to as a focusing point. The foregoing focus adjusting steps (Steps S4-1-S4-5) are repeated so that the focusing point is searched. When it is confirmed that the focusing point is achieved in the Step S4-5, the microcomputer 107 outputs an instruction of selecting the extractor non-passing signal to the selecting unit 104. The selecting unit 104 receives the selecting instruction from the microcomputer 107, and selects the extractor non-passing signal based on the instruction and outputs it (Step S4-6).

The signal processing unit 105 generates the luminance signal and the color difference signal from the extractor non-passing signal and outputs them to the digital zoom unit 106. The digital zoom unit 106 executes the digital zoom process to the luminance signal and the color difference signal based on a zoom setting thereof and outputs the processed signals to the recording device 109. The recording device 109 records the inputted luminance signal and color difference signal (Step S4-7).

Because the luminance signal generated from the extractor passing signal has the abundant volume of information on the high-frequency component, whether or not the focusing point is achieved can be fast and accurately judged in the focus adjusting operation which the microcomputer 107 implements using the luminance signal (Steps S4-4 and S4-5).

However, the extractor passing signal has such an unnatural characteristic that the high-component component is selectively emphasized, which makes it not possible to create a monitor image based on the extractor passing signal. Therefore, when it is judged that the shutter is not pressed in the Step S4-2, the microcomputer 107 outputs an instruction of selecting the extractor non-passing signal to the selecting unit 104. The selecting unit 104 receives the selecting instruction from the microcomputer 107, and selects the extractor non-passing signal based on the instruction and outputs it to the signal processing unit 105 (Step S4-8). The signal processing unit 105 generates the luminance signal and the color difference signal from the extractor non-passing signal.

The microcomputer 107 adjusts the focus using the luminance signal generated from the extractor non-passing signal (Step S4-9). Further, because it is necessary to continuously display the image on the monitor display device 108 in the monitor output mode in which the shutter 114 is not pressed, the luminance signal and color difference signal based on the extractor non-passing signal are outputted and displayed on the monitor display device 108 while the focus is being repeatedly adjusted (S4-10).

In the luminance signal generated from the extractor non-passing signal, the gain of the high-frequency component is decreased, because of which the accuracy and speed of adjusting the focus in such a state are not always high. However, a period when the focus is adjusted based on the luminance signal is not a period for recording but simply the monitor display period, which causes no particular problem in recording the image. On the contrary, the luminance signal outputted during the monitor display period has a natural high-frequency component in which the high-frequency component is not emphasized. Therefore, the monitor display during the monitor display period enables the image to be naturally represented.

As described, when the shutter 114 is pressed, the focusing control is executed based on the extractor passing signal. Therefore, whether or not the focusing point is achieved can be promptly judged. As a result, the focusing point can be reached within a shorter period of time and the focus can be more accurately adjusted. Further, the image signal recorded on the recording device 109 can be prevented from being unnatural because the output of the selecting unit 104 is switched to the extractor non-passing signal after the focus is obtained in the operation of the shutter 114.

### Embodiment 2

An embodiment 2 of the present invention is described referring to the drawings. The embodiment 2 described below is premised on that a digital camera according to the present embodiment comprises an eyepiece display device (hereinafter, referred to as finder) 112 other than the monitor display device 108. The user of the camera may photograph the object while making his/her eyes contact the finder 112 and thereby visually confirming a displayed content of the finder or may photograph the object while disengaging the eyes from the finder 112 and visually confirming the display of the monitor display device 108. Because a display area of the finder 112 is small, the user of the camera photographs the object while mainly observing an atmosphere and focusing state of an entire screen in the case of the confirmation through the finder. On the contrary, the monitor display device 108 has a larger display area and can achieve accurate colors in the displayed image. Therefore, the user of the camera photographs the image while paying attention to the colors of the screen in addition to the atmosphere and focusing state of the entire screen in the case of the confirmation through the monitor display device.

In the present embodiment, the focus adjusting control is executed in different manners in the case in which the user of the camera photographs the image while confirming the displayed content of the finder 112 and in the case in which the user of the camera photographs the image while confirming the displayed content of the monitor display device 108. Below is given a detailed description.

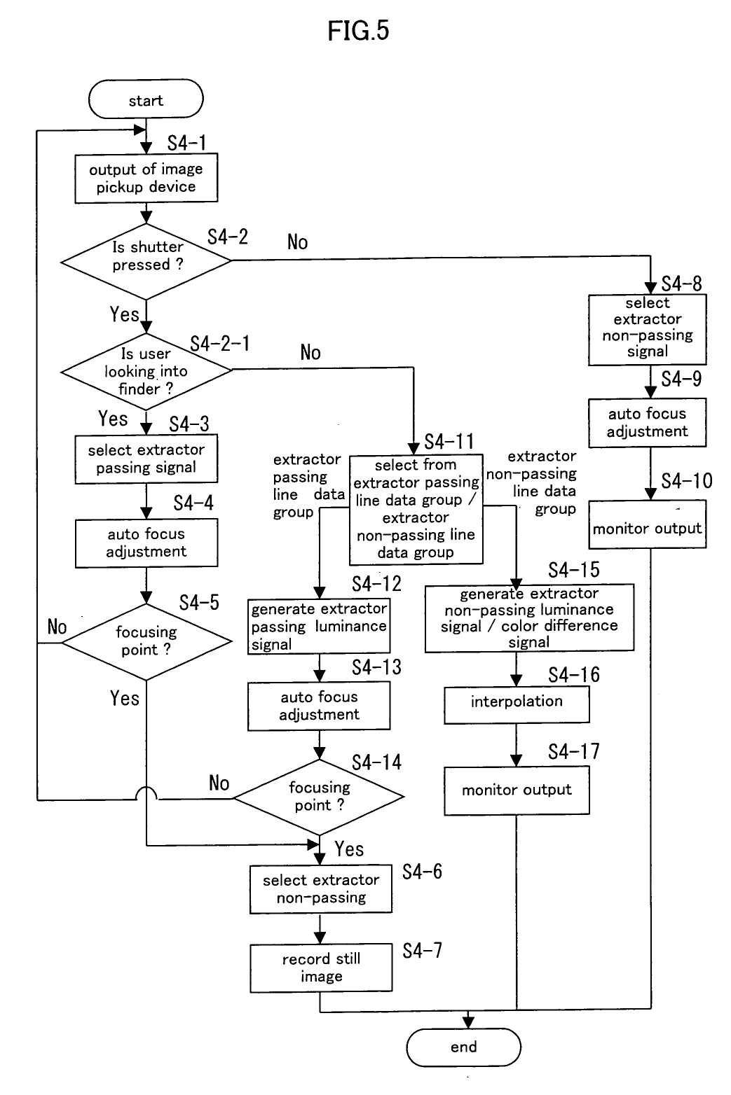

A block diagram of the digital camera according to the embodiment 2, which has the same constitution as in the embodiment 1, is omitted. FIG. 5 is a flow chart of a focus adjusting method according to the embodiment 2. The flow charts shown in FIGS. 4 and 5 include the same steps. Any step shown in FIG. 5, which is identical to any of the steps of FIG. 4, is provided with the same reference symbol and is not described here again.

The focus adjusting method in the case in which the image is not picked up according to the present embodiment is not any different to the method recited in the embodiment 1. The present embodiment is characterized in that it is judged whether or not the user of the camera is looking into the finder 112 when the shutter 114 is pressed, and the focus adjusting method is changed based on the judgment result.

Whether or not he/she is looking into the finder 112 is detected by a detecting device 113 comprised of an optical sensor, a contact sensor or the like, which is provided in a vicinity of the finder 112.

In the present embodiment, in Step S4-2-1 implemented subsequent to the Step S4-2, the microcomputer 107 judges whether or not the user of the camera is looking into the finder 112 when the shutter 114 is pressed. When it is judged that the user of the camera is looking into the finder 112 in the Step S4-2-1, the microcomputer 107 implements the Steps S4-3, S4-4, S4-5, S4-6 and S407 in the same manner as in the embodiment 1.

When it is judged that the user of the camera is not looking into the finder 112 in the Step S4-2-1, the microcomputer 107 outputs next instructions to the selecting unit 104. More specifically, the microcomputer 107 divides respective frame data of the digital image signal outputted from the selecting unit 104 into two groups of line data, and thereafter creates an instruction of selecting the group of line data of the extractor passing signal as one of the groups of line data and an instruction of selecting the group of line data of the extractor non-passing signal as the other of the groups of line data and outputs them to the selecting unit 104.

The selecting unit 104 switches to and from the group of line data of the extractor passing signal (hereinafter, referred to as extractor passing line data group) and the group of line data of the extractor non-passing signal (hereinafter, referred to as extractor non-passing line data group) per line based on the instructions from the microcomputer 107 and outputs one of them (Step S4-11).

The signal processing unit 105 generates an extractor passing luminance signal from the extractor passing line data group and generates an extractor non-passing signal luminance signal/cooler difference signal from the extractor non-passing line data group (Steps S4-12, and S4-15). The signal processing unit 105 selectively outputs the generated extractor non-passing luminance signal/color difference signal to the digital zoom unit 106 and selectively outputs the extractor passing luminance signal to the microcomputer 107.

The microcomputer 107 adjusts the focus using the inputted extractor passing luminance signal (Step S4-13). The focus adjusting operation in the Step S4-13 is not any different to the focus adjusting operation in the Step S4-4. However, only a horizontal high-frequency luminance component is used for the focus adjustment because a vertical component is lost in the extractor passing luminance signal.

The foregoing focus adjusting steps (Steps S4-1-S4-13) are repeatedly implemented so that the focusing point is searched. When it is confirmed the focusing point is obtained in the Step S4-14, the microcomputer 107 returns to the Step S4-6 to output the instruction of selecting the extractor non-passing signal to the selecting unit 104. The selecting unit 104 receives the selecting instruction from the microcomputer 107 and selects and outputs the extractor non-passing signal based on the instruction. The signal processing unit 105 generates the luminance signal and the color difference signal from the extractor non-passing signal and outputs them to the digital zoom unit 106. The digital zoom unit 106 executes the digital zoom process to the luminance signal and the color difference signal based on the zoom setting thereof and outputs them to the recording device 109. The recording device 109 records the inputted luminance signal and the color difference signal (Step S4-7).

As a result of the Step S4-15, the extractor non-passing luminance signal/color difference signal outputted from the signal processing unit 105 to the digital zoom unit 106 are subjected to line interpolation by means of an electronic zoom function of the digital zoom unit 106 (Step S4-16). The digital zoom unit 106 thus exerts its function as the interpolator. The extractor non-passing line data group can be displayed on the monitor display device 108 as a result of the line interpolation. The line-interpolated extractor non-passing line data group is outputted to and displayed on the monitor display device 108 (S4-17). Accordingly, the monitor display device 108 can display a relatively natural image in the focusing process because the image signal supplied to the monitor display device 108 in the focusing process is the image signal in which the extractor non-passing line data group is interpolated and the high-frequency component in the data remains natural though interpolated.

The extractor passing line data group and the extractor non-passing line data group can be set, for example, as follows. All of the line data are divided into continuous three line teams, and one of the divided line teams is allocated to the extractor passing line data group and the remaining two are allocated to the extractor non-passing line data group.

It is unnecessary to output the data to the monitor display device 108 when the user of the camera is looking into the finder 112, in which state the focus is adjusted based on the extractor passing signal. On the contrary, it is necessary to output the data to the monitor display device 108 when the user of the camera is not looking into the finder 112. Therefore, the focus is adjusted using the line data group of the extractor passing signal, and the line data group of the extractor non-passing signal is interpolated and outputted to the monitor display device 108. In the foregoing manner, the user of the camera can confirm the natural image through the monitor display device 108 during the very accurate focus adjustment using the high-frequency component of the luminance signal.

The image displayed on the finder 112 in the state in which the user of the camera is looking into the finder 112 is not interpolated. However, because the display area of the finder 112 is small having the size of a few centimeters square, the image does not substantially include any particular problem without the interpolation.

The present invention is capable of adjusting the focus at a high speed and with a high accuracy, and therefore, can be applied to a digital camera, a typical example of which is a digital still camera.

While there has been described what is at present considered to be preferred embodiments of this invention, it will be understood that various modifications may be made therein, and it is intended to cover in the appended claims all such modifications as fall within the true spirit and scope of this invention.

1. A focus adjusting method comprising:
an image signal converting step in which an imaging light entering an optical lens mechanism is converted into an image signal;
an extracting step in which a high-frequency component of the image signal is selectively extracted;
a signal generating step in which a luminance signal and a color difference signal are generated from the high-frequency component of the image signal selectively extracted;
and a focus adjusting step in which a focusing position of the optical lens mechanism is adjusted using a high-frequency component of the luminance signal.

2. A focus adjusting method as claimed in claim 1, further comprising a selecting step in which the high-frequency component of the image signal is selected and outputted at a timing of the adjustment of the focusing position in recording an image and the image signal is selected and outputted at any timing other than the timing of the adjustment of the focusing position after the image signal generating step is implemented, wherein
the luminance signal and the color difference signal are generated from a signal component selected in the selecting step in the signal generating step, and
the high-frequency component of the luminance signal generated in the signal generating step at the timing of the adjustment of the focusing position is used to adjust the focusing position of the optical lens mechanism in the focus adjusting step.

3. A focus adjusting method as claimed in claim 2, wherein
the image signal is selected and outputted after a focusing point is obtained at the timing of the adjustment of the focusing position in the selecting step.

4. A focus adjusting method for adjusting a focus of a digital camera comprising an eyepiece display device and a monitor display device using the focus adjusting method as claimed in claim 2, wherein
line data constituting respective frame data of the image signal is divided into two groups of line data, and the line data group of the high-frequency component of the image signal is selected at an output timing of one of the line data groups and the line data group of the image signal is selected at an output timing of the other line data group in the selecting step, and the focusing position of the optical lens mechanism is adjusted using the line data group of the high-frequency component of the image signal in the focus adjusting step when a user of the camera does not have his/her eyes contact the eyepiece display device at the timing of the adjustment of the focusing position, and
the high-frequency component of the image signal is selected in the selecting step and the high-frequency component of the image signal is used in the focus adjusting step in adjusting the focusing position of the optical lens mechanism when the user of the camera has his/her eyes contact the eyepiece display device at the timing of the adjustment of the focusing position.

5. A focus adjusting method as claimed in claim 4, further comprising an interpolating step in which the luminance signal and the color difference signal generated based on the line data group of the image signal are interpolated and outputted to the monitor display device at the output timing of the other line data group.

6. A focus adjusting device comprising:
an optical lens mechanism;
an image pickup device for converting an imaging light entering the optical lens mechanism into an image signal;
an extracting unit for selectively extracting a high-frequency component of the image signal;
a signal processing unit for generating a luminance signal and a color difference signal from the high-frequency component of the image signal extracted by the extracting unit; and
a focus adjusting unit for adjusting a focusing position of the optical lens mechanism using a high-frequency component of the luminance signal.

7. A focus adjusting device as claimed in claim 6, further comprising a selecting unit for selecting from an output of the image pickup device and an output of the extracting unit and outputting the selected output, wherein
the signal processing unit generates the luminance signal and the color difference signal from the output of the selecting unit.

8. A focus adjusting device as claimed in claim 7, wherein
the selecting unit selects the high-frequency component of the image signal outputted from the extracting unit at a timing of the adjustment of the focusing position in recording an image using the image pickup device, and the image signal outputted from the image pickup device is selected at any timing other than the timing of the adjustment of the focusing position in recording the image using the image pickup device.

9. A focus adjusting device as claimed in claim 8, wherein
the selecting unit selects the image signal outputted from the image pickup device after focusing point is obtained at the timing of the adjustment of the focusing position in recording the image using the image pickup device.

10. A digital camera comprising:
the focus adjusting device as claimed in claim 8;
an eyepiece display device for displaying an image through the eyepiece display device using the luminance signal and the color difference signal outputted from the signal processing unit;
a monitor display device for displaying a monitor image using the luminance signal and the color difference signal outputted from the signal processing unit; and
a detecting device for detecting whether or not a user of the camera has his/her eyes contact the eyepiece display device, wherein
the selecting unit divides line data constituting respective frame data of the image signal into two groups of line data and selects the line data group outputted from the extracting unit and outputs the selected line data group to the signal processing unit at an output timing of one of the line data groups, while selecting the line data group outputted from the image pickup device and outputs the selected line data group to the signal processing unit at an output timing of the other line data group, and the focus adjusting unit adjusts the focusing position of the optical lens mechanism using the line data group of the high-frequency component of the image signal when the detecting device judges that the user of the camera does not have his/her eyes contact the eyepiece display device at the timing of the adjustment of the focusing position in recording the image using the image pickup device, and
the selecting unit selects the image signal outputted from the image pickup device and outputs the selected image signal to the signal processing unit, and the focus adjusting unit adjusts the focusing position of the optical lens mechanism using the high-frequency component of the image signal when the detecting device judges that the user of the camera has his/her eyes contact the eyepiece display device at the timing of the adjustment of the focusing position in recording the image using the image pickup device.

11. A digital camera as claimed in claim 10, further comprising an interpolating device for interpolating the luminance signal and the color difference signal generated in the signal processing unit based on the line data group outputted from the image pickup device at the output timing of the other line data group and outputting the interpolated signals to the monitor display device.
